(19) United States
(12) Patent Application Publication
(10) Pub. No.: US 2014/0297945 A1
(43) Pub. Date: Oct. 2, 2014

(54) STORAGE APPARATUS AND COPY CONTROL METHOD

(71) Applicant: FUJITSU LIMITED, Kawasaki-shi (JP)

(72) Inventors: Kinya SAITO, Kawasaki (JP); Masahiro Yamamoto, Kawasaki (JP); Yujiro Hata, Yokohama (JP)

(73) Assignee: FUJITSU LIMITED, Kawasaki-shi (JP)

(21) Appl. No.: 14/154,559

(22) Filed: Jan. 14, 2014

(30) Foreign Application Priority Data
Mar. 28, 2013 (JP) 2013-070674

(51) Int. Cl. G06F 3/06

(52) U.S. Cl. CPC G06F 3/065; G06F 3/0689; G06F 3/0619
USPC 711/114

(57) ABSTRACT

A storage apparatus includes a plurality of drives having different response speeds, a memory that stores location information of data stored in the plurality of drives, and a processor operable to execute performing rearrangement of the data among the plurality of drives in accordance with a specific condition, updating the location information of the data whose rearrangement has been performed, and starting copying from data that is used for startup of a host connected to another storage apparatus among a plurality of pieces of data to be copied to the other storage apparatus in accordance with the location information stored in the memory, the other storage device being redundantly configured with the storage apparatus.

### CROSS-REFERENCE TO RELATED APPLICATION

This application is based upon and claims the benefit of priority from the prior Japanese Patent Application No. 2013-070674 filed on Mar. 28, 2013, the entire contents of which are incorporated herein by reference.

### FIELD

The embodiments discussed herein are related to a storage apparatus.

### BACKGROUND

In recent years, in storage apparatuses, an automatic tier control of storage devices is utilized, which combines storage devices of different types of access response performance or capacity, and performs appropriate arrangement of data in accordance with actual access range and access frequency between the storage devices. With the automatic tier control of storage devices, arrangement of data is made to a storage device with an appropriate capacity according to an access range. Furthermore, with the automatic tier control of storage devices, arrangement of data with a high access frequency is made to an appropriate storage device.

FIGS. 19 and 20 are diagrams for explaining the automatic tier control of storage devices. In FIGS. 19 and 20, a volume is formed so as to cross over a plurality of storage devices, including a solid state drive (SSD) and/or a hard disk drive (HDD). As illustrated in FIG. 19, in the automatic tier control, a data block (hereinafter, will be referred to as a block) with a high access frequency (frequently accessed) is arranged, for example, in an SSD area with a high response performance (short response time). Furthermore, in the automatic tier control, a block with a low access frequency (infrequently accessed) is arranged, for example, in a Nearline HDD area with a low response performance (long response time). Accordingly, with the automatic tier control, an optimal arrangement state based on access frequency may be generated.

As illustrated in FIG. 20, in the automatic tier control, the arrangement location of the blocks is changed according to access frequency. Here, with the automatic tier control, the arrangement location of a block A is changed, according to an increase in the access frequency, from the Nearline HDD area to an Online HDD area. Furthermore, with the automatic tier control, the arrangement location of a block B is changed, according to a decrease in the access frequency, from the Online HDD area to the Nearline HDD area. Moreover, with the automatic tier control, the arrangement location of a block C is changed, according to an increase in the access frequency, from the Online HDD area to the SSD area. The arrangement location of each block is managed on a management table.

In order to maintain the availability of the entire storage system, as a way to ensure data integrity within a main-site (main-system) which normally operates, a storage device that stores the same data is built in a remote site (sub-system). A technique to transfer data to be backed up by using a function of a storage area network (SAN) between the storage devices of the SAN, is disclosed. With such a technique, file transfer processing such as a backup is performed by providing a scenario to perform in sequence a series of multiple commands, and by running the scenario.

Japanese Laid-open Patent Publication No. 2003-316633 is an example of the above mentioned related art.

With the storage apparatus using the automatic tier control, performance improvement in the operating state is performed, in which data with a high access frequency is arranged in a storage device with a fast access speed, and data with a low access frequency is arranged in a storage device with a slow access speed. In contrast, as a purpose of the remote site, in a case where the main-site enters an unusable state, the remote site is started quickly, in an attempt to resume or continue an operation. However, with the storage apparatus using the automatic tier control, there is a problem in that data important for startup is not copied quickly, and for example, when the main-site goes down, the remote site is not able to be started quickly.

The above-mentioned problem will be explained, with reference to FIG. 21. FIG. 21 is a diagram for explaining an existing data copying to a remote site under an automatic tier control. As illustrated in FIG. 21, with the automatic tier control, the arrangement location of a block A is changed, according to an increase in the access frequency, from an Online HDD area to an SSD area. With the automatic tier control, the arrangement location of a block B is changed, according to a decrease in the access frequency, from the Online HDD area to a Nearline HDD area. With the automatic tier control, the arrangement location of a block C is changed, according to an increase in the access frequency, from the Nearline HDD area to the Online HDD area. Furthermore, based on the latest state, the main-site copies the blocks to the same tier on the remote site, in the order of the high-performance SSD area, the HDD area, and the Nearline HDD area.

In the above-mentioned case, there is a possibility that the degree of importance of the block located in the highest tier under the tier control of the storage apparatus in the main-site and the degree of importance of the block used to start the remote site side are not equal to each other. That is, the block used to start the remote site is normally accessed only at the time of startup, and is seldom accessed during the later operation state. Therefore, such a block may be moved to a tier with low performance requests. Thus, in the case where the main-site goes down, the startup of the remote site is performed after the blocks in all the tiers have been copied. That is, in the case where the main-site goes down, at the remote site, the startup is not performed until the blocks in all the tiers have been copied, therefore making the remote site unable to be started quickly.

The above-mentioned problem appears not only on the automatic tier control which generates an arrangement state based on access frequency but also on the automatic tier control which generates an arrangement state based on a specific condition, such as, an elapsed time or the like, for example, least recently used (LRU).

### SUMMARY

According to an aspect of the invention, a storage apparatus includes a plurality of drives having different response speeds, a memory that stores location information of data stored in the plurality of drives, and a processor operable to execute performing rearrangement of the data among the plurality of drives in accordance with a specific condition, updating the location information of the data whose rearrangement has been performed, and starting copying from data that is used for startup of a host connected to another storage apparatus among a plurality of pieces of data to be copied to the other storage apparatus in accordance with the location information stored in the memory, the other storage device being redundantly configured with the storage apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the hardware configuration of a storage system according to a first embodiment;

FIG. 2 is a diagram for explaining the degree of importance;

FIG. 3 is a diagram for explaining startup of a server;

FIG. 4A is a diagram for explaining setting of the degree of importance based on the access order of volumes;

FIG. 4B is a diagram for explaining setting of the degree of importance based on the access order and the access frequency of volumes;

FIG. 5 is a diagram illustrating an example of the data structure of a degree-of-importance management table;

FIG. 6 is a diagram for explaining a specific example of copy control;

FIG. 7 is a diagram illustrating the contents of a degree-of-importance management table for copy control;

FIG. 8 is a first diagram for explaining a specific example of return copy control;

FIG. 9 is a second diagram for explaining a specific example of return copy control;

FIG. 10A is a flowchart of a degree-of-importance setting process according to the first embodiment;

FIG. 10B is a flowchart of a process for determining the degree of importance in accordance with a name;

FIG. 11 is a flowchart of a copy control process according to the first embodiment;

FIG. 12 is a flowchart of a return copy control process according to the first embodiment;

FIG. 13 is a diagram illustrating the hardware configuration of a storage system according to a second embodiment;

FIG. 14 is a diagram illustrating an example of the data structure of a copied block table;

FIG. 15 is a diagram for explaining a specific example of copy control;

FIG. 16 is a diagram for explaining a detailed specific example of copy control according to the second embodiment;

FIGS. 17A and 17B are flowcharts of a copy control process according to the second embodiment;

FIG. 18 is a diagram illustrating another example of the configuration of a storage system;

FIG. 19 is a first diagram for explaining automatic tier control of a storage apparatus;

FIG. 20 is a second diagram for explaining the automatic tier control of the storage apparatus; and

FIG. 21 is a diagram for explaining existing data copying to a remote site under automatic tier control.

### DESCRIPTION OF EMBODIMENTS

Hereinafter, embodiments of a storage apparatus, a copy control program, and a copy control method disclosed in this application will be described below with reference to the drawings. The embodiments are applied to storage apparatuses that perform automatic tier control of storage devices for arranging data appropriately in accordance with specific conditions including the access range, access frequency, and the like. However, the embodiments do not intend to limit the scope of the application. Furthermore, embodiments may be combined appropriately without causing contradiction of processing details.

### First Embodiment

### Configuration of Storage System

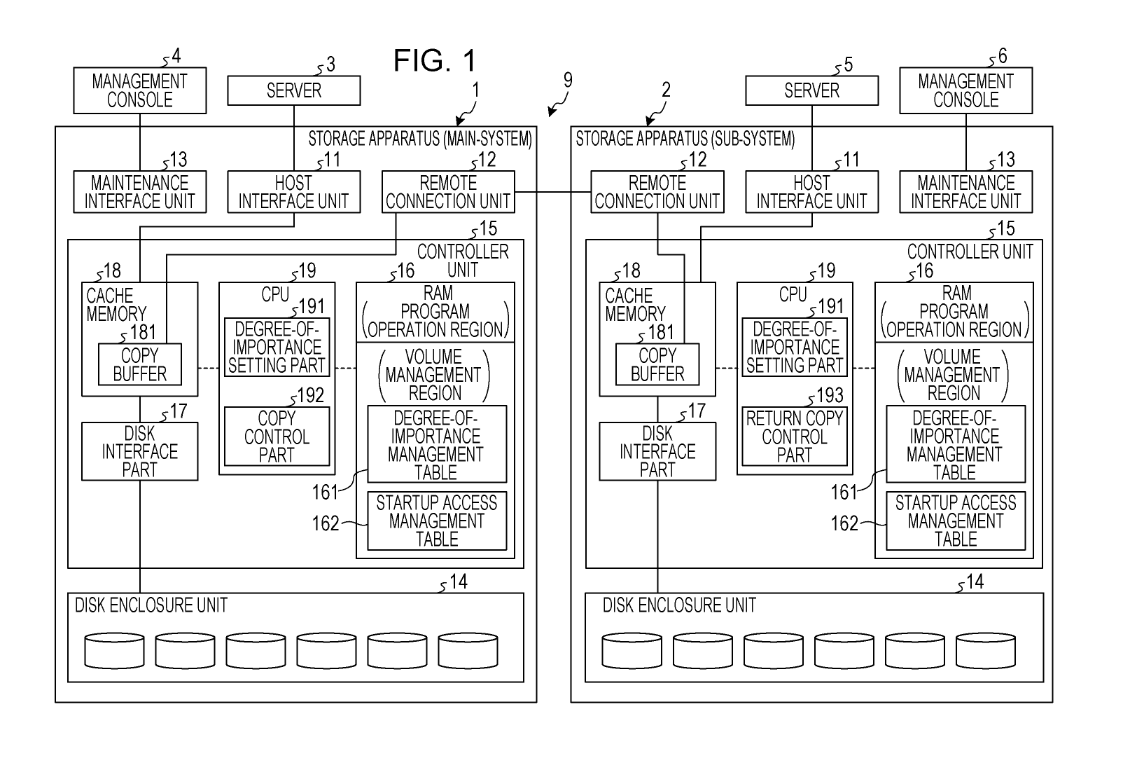

FIG. 1 is a diagram illustrating the hardware configuration of a storage system according to a first embodiment. As illustrated in FIG. 1, a storage system 9 includes storage apparatuses 1 and 2. In the storage system 9, for example, one of the storage apparatuses 1 and 2 operates as a primary site (main-system) and the other one of the storage apparatuses 1 and 2 remains in a standby state as a secondary site (sub-system). A disaster recovery site (DR site) is an example of a secondary side that is in a standby state. Hereinafter, explanations will be provided below for the storage apparatus 1 defined as a main-system and the storage apparatus 2 defined as a sub-system.

The storage apparatus 1 includes a host interface unit 11, a remote connection unit 12, a maintenance interface unit 13, a disk enclosure unit 14, and a controller unit 15.

The host interface unit 11 is a connection interface with respect to a server 3. The server 3 stores a program and data to be used for startup (launching) in the storage apparatus 1. At the time of startup, the server 3 reads the program and data to be used for startup from the storage apparatus 1, and is started in accordance with the read program and data.

The remote connection unit 12 is a connection interface with respect to the storage apparatus 2. The maintenance interface unit 13 is a connection interface with respect to a management console 4. The management console 4 is an input/output device used for management of the storage apparatus 1, and corresponds to, for example, a display and a keyboard.

The disk enclosure unit 14 is an enclosure in which storage devices having different response speeds are mounted. The storage devices having different response speeds include, for example, an SSD, a Nearline HDD, and an Online HDD. The SSD has the highest response speed of these storage devices. The Nearline HDD has the lowest response speed of these storage devices. The Online HDD has a response speed slower than the response speed of the SSD and higher than the response speed of the Nearline HDD. Each volume is formed so as to virtually cross over these storage devices. In automatic tier control, data is rearranged in an appropriate tier within a virtually formed volume, in accordance with specific conditions including the access range, access frequency, and the like. For example, with the automatic tier control, data that is frequently accessed is arranged in an SSD tier having a high response speed, and data that is not frequently accessed is arranged in a Nearline HDD tier having a low response speed. Accordingly, under the automatic tier control, an optical arrangement state is generated, for example, according to the access frequency. The automatic tier control is executed by a central processing unit (CPU) 19, which will be described later, for example. The automatic tier control is an example of a rearrangement control unit.

The controller unit 15 includes a random access memory (RAM) 16, a disk interface part 17, a cache memory 18, and the CPU 19.

The RAM 16 contains a program operation region and a volume management region. The program operation region is used when a specific program runs, for example, when a copy control program in the first embodiment runs. The volume management region is used for management of volumes. The volume management region contains, for example, a degree-of-importance management table 161 and a startup access management table 162.

The degree-of-importance management table 161 manages, for each volume, the degree of importance regarding startup (launching) of a server. That is, the degree-of-importance management table 161 manages, for each data block within a volume, degree-of-importance information representing the degree of importance regarding startup of a server. A block contains data to be used for startup of a server, data used for operation of an application, and the like. The degree-of-importance management table 161 manages the degree of importance regarding startup (launching) of a server 5 of a sub-system when viewed from the main-system, and manages the degree of importance regarding startup (launching) of the server 3 of the main-system when viewed from the sub-system. The data structure of the degree-of-importance management table 161 will be described later.

The startup access management table 162 manages the status of access to each volume at the time of startup of the server 3. The access status includes, for example, the order of access to volumes and the frequency of access to the volumes. The startup access management table 162 is used when the degree of importance is set in the degree-of-importance management table 161.

The disk interface part 17 is a connection interface with respect to the disk enclosure unit 14. The cache memory 18 includes a copy buffer 181. The copy buffer 181 is used when a copy control part 192, which will be described later, copies a block to the storage apparatus 2.

The CPU 19 includes a degree-of-importance setting part 191 and the copy control part 192. The CPU 19 develops the copy control program according to the first embodiment into the program operation region of the RAM 16 and executes the program as a process. The process corresponds to the degree-of-importance setting part 191 and the copy control part 192.

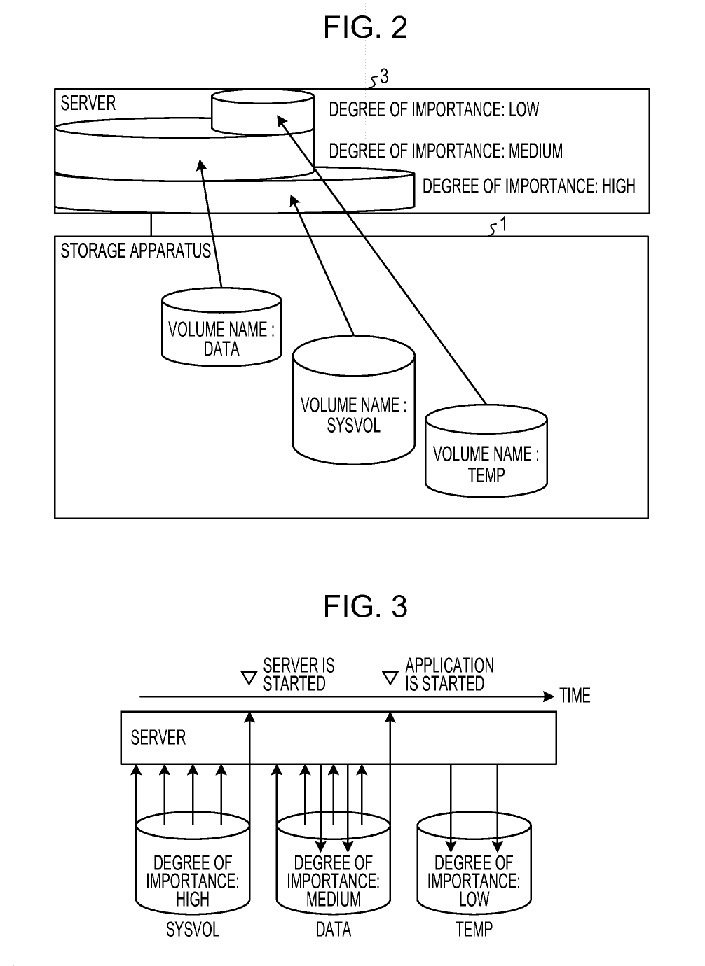

The degree-of-importance setting part 191 sets, for each volume, the degree of importance regarding startup of a server. The degree of importance mentioned here is associated with a volume, from the viewpoint of the degree of necessity for startup of a server. The degree of importance will be explained below with reference to FIG. 2. Furthermore, startup of a server will be explained below with reference to FIG. 3. The explanation for the server 3 will be provided below on behalf of the servers 3 and 5.

FIG. 2 is a diagram for explaining the degree of importance. As illustrated in FIG. 2, in the server 3, data of a “high degree of importance”, which represents that the degree of importance is high, corresponds to, for example, a base program and data (OS startup data) used for startup of a server. Data of a “medium degree of importance”, which represents that the degree of importance is medium, corresponds to, for example, an application that runs on the server 3 and data for starting the application (application startup data). Data of a “low degree of importance”, which represents that the degree of importance is low, corresponds to, for example, data of a temporary region for an application operation. Data of a “high degree of importance” is stored in, for example, a volume having the volume name of “SYSVOL” in the storage apparatus 1. The data of a “medium degree of importance” is stored in, for example, a volume having the volume name of “DATA” in the storage apparatus 1. The data of a “low degree of importance” is stored in, for example, a volume having the volume name of “TEMP” in the storage apparatus 1.

FIG. 3 is a diagram for explaining startup of a server. As illustrated in FIG. 3, the server 3 reads data of a “high degree of importance” from a volume having the volume name of “SYSVOL” in the storage apparatus 1, and starts a server. Then, the server 3 starts an application by reading data of a “medium degree of importance” from a volume having the volume name of “DATA” in the storage apparatus 1 and writing the data into the volume. Then, the server 3 uses a volume having the volume name of “TEMP” in the storage apparatus 1 as a temporary region of an application operation.

Referring back to FIG. 1, as an example, at the time of generating a volume that is arranged so as to cross over a plurality of storage devices, the degree-of-importance setting part 191 sets in the degree-of-importance management table 161 the degree of importance of a block stored in the volume, in accordance with the name of the volume. The plurality of storage devices include storage devices having different response speeds, for example, an SSD, an Online HDD, and a Nearline HDD. More specifically, the degree-of-importance setting part 191 acquires a volume name, and generates a volume having the acquired volume name so as to virtually cross over a plurality of storage devices. For example, if the volume name contains “SYS”, the degree-of-importance setting part 191 determines that the degree of importance is “high”. For example, if the volume name contains “DATA”, the degree-of-importance setting part 191 determines that the degree of importance is “medium”. For example, the volume name contains “TEMP”, the degree-of-importance setting part 191 determines that the degree of importance is “low”. The degree-of-importance setting part 191 records the determined degree of importance in association with the volume name into the degree-of-importance management table 161.

As another example, at the time of generating a volume so as to cross over a plurality of storage devices, the degree-of-importance setting part 191 sets in the degree-of-importance management table 161 the degree of importance of a block stored in the volume, on the basis of information of a pair of the name and the degree of importance of the volume. More specifically, the degree-of-importance setting part 191 acquires the name and the degree of importance of a volume, and generates the volume having the acquired volume name so as to virtually cross over a plurality of storage devices. Then, the degree-of-importance setting part 191 records the acquired name of the volume and the acquired degree of importance of the volume in association with each other into the degree-of-importance management table 161.

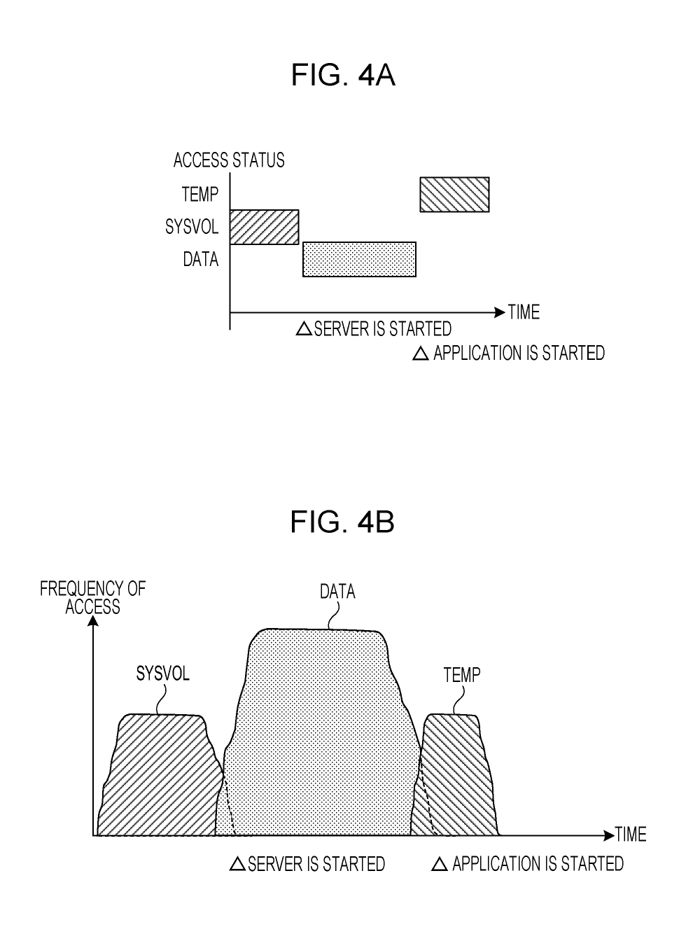

Furthermore, as still another example, at the time when the server 3 is started, the degree-of-importance setting part 191 sets in the degree-of-importance management table 161 the degree of importance of a block stored in a volume generated so as to cross over a plurality of storage devices, on the basis of the access order and the access frequency of the volume. Here, setting of the degree of importance based on the access order of volumes will be explained below with reference to FIG. 4A. Furthermore, setting of the degree of importance based on the access order and the access frequency of volumes will be explained below with reference to FIG. 4B.

FIG. 4A is a diagram for explaining setting of the degree of importance based on the access order of volumes. In FIG. 4A, the horizontal axis represents time and the vertical axis represents access status. The server 3 accesses a volume having the volume name of “SYSVOL” at the earliest access stage, and starts a server. As time passes, the server 3 accesses a volume having the volume name of “DATA”, and starts an application. Then, in order to operate the application, the server 3 accesses a volume having the volume name of “TEMP”. As is clear from the above description, the server 3 accesses the volumes in the order of the volume names of “SYSVOL”, “DATA”, and “TEMP”.

FIG. 4B is a diagram for explaining setting of the degree of importance based on the access order and the access frequency of volumes. In FIG. 4B, the horizontal axis represents time and the vertical axis represents access frequency. At the earliest access stage, the server 3 accesses the volume having the volume name of “SYSVOL” at an access frequency higher than the other volumes. As time passes, the server 3 accesses the volume having the volume name of “DATA” at an access frequency higher than the other volumes. Then, the server 3 accesses the volume having the volume name of “TEMP” at an access frequency higher than the other volumes. As is clear from the above description, as time passes, the server 3 accesses the volumes at the highest frequency in the order of the volume names of “SYSVOL”, “DATA”, and “TEMP”.

Referring back to FIG. 1, more specifically, at the time of startup of the server 3, the degree-of-importance setting part 191 records, with the lapse of time, the access frequency of each volume into the startup access management table 162. Then, on the basis of the information recorded in the startup access management table 162, the degree-of-importance setting part 191 records the degree of importance in association with a volume name into the degree-of-importance management table 161. That is, the degree-of-importance setting part 191 sets “high degree of importance”, “medium degree of importance”, and “low degree of importance” for volumes accessed at an access frequency higher than the other volumes in chronological order.

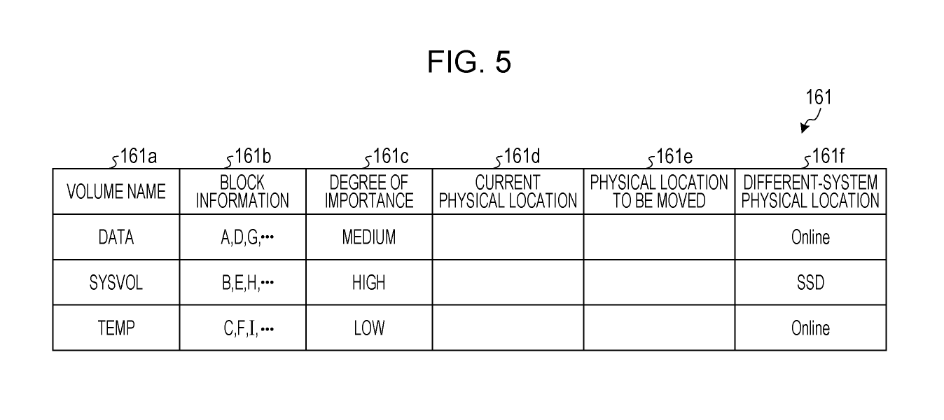

Here, the data structure of the degree-of-importance management table 161 will be explained below with reference to FIG. 5. FIG. 5 is a diagram illustrating an example of the data structure of a degree-of-importance management table. As illustrated in FIG. 5, a volume name 161a, block information 161b, the degree of importance 161c, a current physical location 161d, a physical location to be moved 161e, and a different-system physical location 161f are stored in association with one another in the degree-of-importance management table 161. The term “different-system” in the “different-system physical location 161f” represents the storage apparatus 2 and the server 5 when viewed from the storage apparatus 1 and the server 3, and represents the storage apparatus 1 and the server 3 when viewed from the storage apparatus 2 and the server 5.

The volume name 161a represents the name of a volume. The block information 161b represents identification information of a block stored in a volume. The block information 161b represents a physical range in which a block is arranged, and is determined in accordance with the capacity specified when a volume is generated. The degree of importance 161c represents the degree of importance regarding startup of a server. For example, “high”, which represents that the degree of importance is high, “medium”, which represents that the degree of importance is medium, and “low”, which represents that the degree of importance is low, are stored in the degree of importance 161c. The current physical location 161d represents location information representing the physical location at which a block is currently arranged. For example, “SSD”, which represents an SSD, “Online”, which represents an Online HDD, and “NearLine”, which represents a Nearline HDD, are stored in the current physical location 161d. The current physical location 161d is updated, for example, when a block is rearranged under the automatic tier control. The physical location to be moved 161e represents the physical location to which a block is to be moved in the next automatic tier control after access evaluation for a specific observation period has been performed. The different-system physical location 161f represents the physical location within a storage device of a storage apparatus of a different system at which data is arranged when a block is copied to the storage apparatus of the different system. The different-system physical location 161f may be set in advance by the degree-of-importance setting part 191 in accordance with the configuration of the storage device of the storage apparatus of the different system. For example, the degree-of-importance setting part 191 may set a physical location for the different-system physical location 161f in such a manner that a block of a high degree of importance is arranged in a storage device of a high response speed.

As an example, in the case where the volume name 161a is “DATA”, “A, D, G” is stored as the block information 161b, “medium” is stored as the degree of importance 161c, and “Online” is stored as the “different-system physical location 161f.

Referring back to FIG. 1, the copy control part 192 copies data to the storage apparatus 2 of the different system with specific time intervals, in order to ensure the consistency of data between the storage apparatus 1 and the storage apparatus 2. At the time of copying data to the storage apparatus 2 of the different system, the copy control part 192 controls the processing order of data copying, on the basis of the degree of importance stored in the degree-of-importance management table 161. A specific time interval may be, for example, daily, weekly, or monthly.

For example, the copy control part 192 determines the order of transmission of blocks within volumes, in descending order of the degree of importance of a volume stored in the degree-of-importance management table 161. The copy control part 192 copies blocks to the storage apparatus 2 of the different system in the determined transmission order. That is, in the case where the volume name “SYSVOL” has a “high” degree-of-importance, the copy control part 192 performs copying from a block within “SYSVOL”. Accordingly, since the copy control part 192 is capable of preferentially copying data to be used for startup of a server to the storage apparatus 2 of the different system, even if the server 3 of the own system enters an unusable state, such as a down state, the server 5 of the different system may be started quickly.

Here, at the time of copying a block to the storage apparatus 2 of the different system, the copy control part 192 transmits identification information of the block and the different-system physical location, which is the physical location at which the block is to be arranged in the storage apparatus 2 of the different system, as well as the block. Accordingly, the storage apparatus 1 is capable of copying a block to a storage device represented by the different-system physical location of the storage apparatus 2 of the different system. The copy control part 192 may collectively transmit different-system physical locations of blocks before copying the blocks, instead of at the time of copying the blocks.

Regarding the storage apparatus 2, the same components as those in the storage apparatus 1 will be referred to with the same reference signs, and explanations for the same configuration and operation as the storage apparatus 1 will be omitted. The storage apparatus 2 is different from the storage apparatus 1 in that the CPU 19 further includes a return copy control part 193, the host interface unit 11 is connected to the server 5, and the maintenance interface unit 13 is connected to a management console 6.

When the server 3 of the main-system enters an unusable state, such as a down state, the return copy control part 193 starts the server 5 of the sub-system by using data to be used for startup of a server stored in a storage device accommodated in the disk enclosure unit 14 of the storage apparatus 2 of the sub-system. Here, in the case where blocks transmitted from the storage apparatus 1 are being copied, after copying of a block including data to be used for startup of a server has been completed, the return copy control part 193 starts the server 5. For example, after copying of a block corresponding to a volume having a “high” degree of importance has been completed, the return copy control part 193 starts the server 5.

Furthermore, when the server 3 of the main-system is recovered, the return copy control part 193 controls the processing order of copy processing for returning data to the storage apparatus 1, on the basis of the degree of importance stored in the degree-of-importance management table 161. For example, the return copy control part 193 determines the order of transmission of blocks within volumes, in descending order of the degree of importance of a volume stored in the degree-of-importance management table 161. Then, the return copy control part 193 copies the blocks to the storage apparatus 1 of the main-system in the determined transmission order.

Specific Example of Copy Control

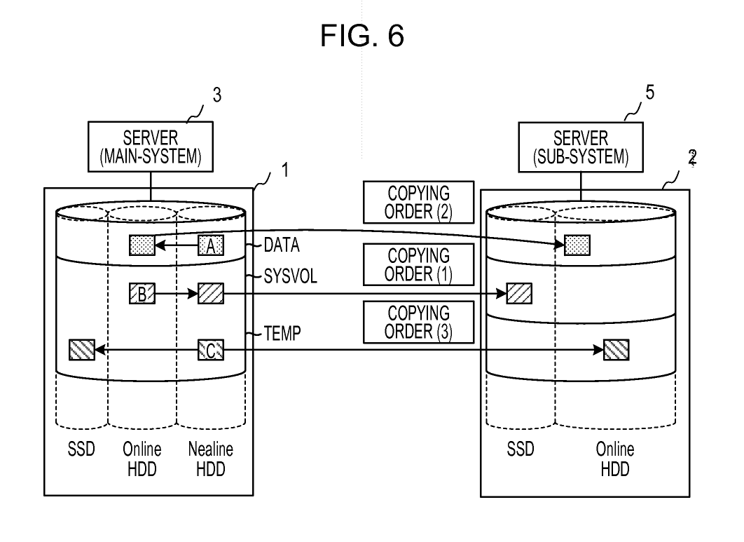

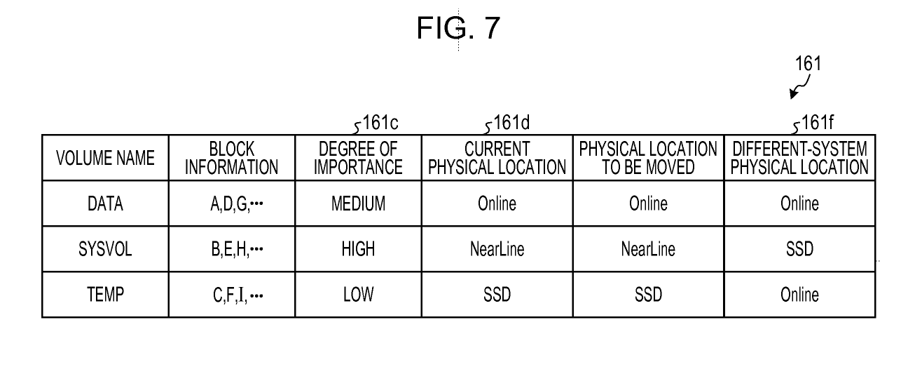

Next, a specific example of copy control will be explained below with reference to FIGS. 6 and 7. FIG. 6 is a diagram for explaining a specific example of copy control. FIG. 7 is a diagram illustrating the contents of a degree-of-importance management table for copy control. The degree of importance regarding startup of a server is stored, for each volume, in the degree of importance 161c of the degree-of-importance management table 161. In this example, the degree of importance of a volume having the volume name “SYSVOL” is “high”, the degree of importance of a volume having the volume name “DATA” is “medium”, and the degree of importance of a volume having the volume name “TEMP” is “low”.

In FIG. 6, copy control for blocks from the storage apparatus 1 of the main-system to the storage apparatus 2 of the sub-system is illustrated. In the storage apparatus 1 of the main-system, the arrangement location of a block A is moved from the Nearline HDD to the Online HDD under the automatic tier control. Furthermore, the arrangement location of a block B is moved from the Online HDD to the Nearline HDD under the automatic tier control. Furthermore, the arrangement location of a block C is moved from the Nearline HDD to the SSD under the automatic tier control.

As illustrated in FIG. 7, the current physical location 161d of the block A is set to “Online”. Furthermore, the current physical location 161d of the block B is set to “NearLine”. Furthermore, the current physical location 161d of the block C is set to “SSD”.

Then, the copy control part 192 copies blocks to the storage apparatus 2 of the sub-system in descending order of the degree of importance of a volume stored in the degree-of-importance management table 161. In this example, the copy control part 192 copies a block corresponding to “SYSVOL” having a “high” degree-of-importance, a block corresponding to “DATA” having a “medium” degree-of-importance, and a block corresponding to “TEMP” having a “low” degree of importance in that order.

The copy control part 192 specifies the different-system physical location 161f stored in the degree-of-importance management table 161 as the arrangement location in the storage apparatus 2. Here, a block corresponding to “SYSVOL” of a “high” degree of importance is arranged in the SSD. A block corresponding to “DATA” of a “medium” degree of importance and a block corresponding to “TEMP” of a “low” degree of importance are arranged in the Online HDD.

The copy control part 192 is capable of preferentially copying a block including data of a high degree of importance regarding startup of a server to a sub-system, as described above. Consequently, even in the case where the server 3 of the main-system is down, since the storage apparatus 2 of the sub-system is capable of quickly acquiring data of a high degree of importance, the time up to startup of the server 5 may be shortened.

Specific Example of Return Copy Control

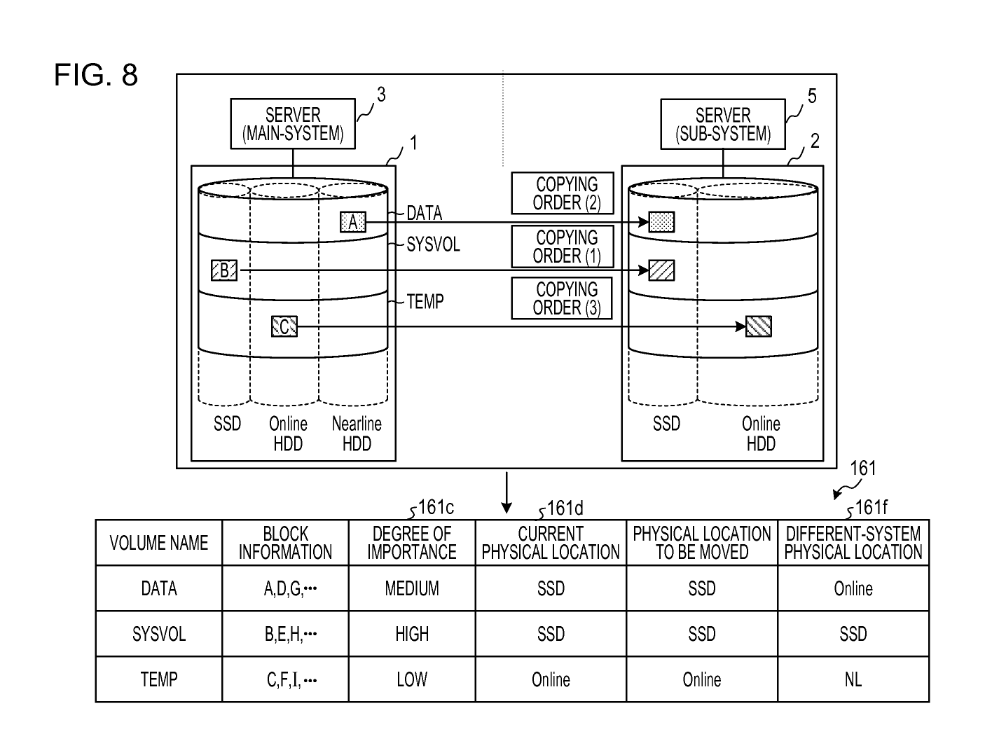

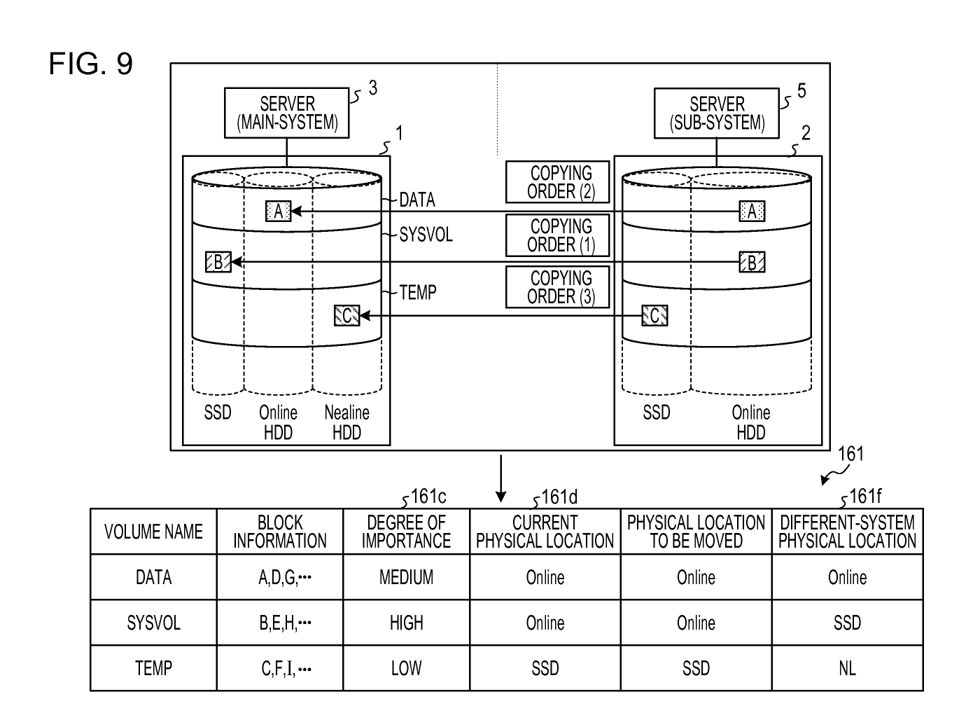

Next, a specific example of return copy control will be explained below with reference to FIGS. 8 and 9. FIGS. 8 and 9 are diagrams for explaining specific examples of return copy control. The degree of importance regarding startup of a server is stored, for each volume, in the degree of importance 161c of the degree-of-importance management table 161 of each of the main-system and the sub-system. In this example, the degree of importance of a volume having the volume name “SYSVOL” is “high”, the degree of importance of a volume having the volume name “DATA” is “medium”, and the degree of importance of a volume having the volume name “TEMP” is “low”.

As illustrated in an upper part of FIG. 8, the storage apparatus 1 of the main-system copies the blocks B, A, and C to the storage apparatus 2 of the sub-system in the order of a volume having the volume name of “SYSVOL”, which has a “high” degree-of-importance, a volume having the volume name of “DATA”, which has a “medium” degree-of-importance, and a volume having the volume name of “TEMP”, which has a “low” degree-of-importance. As a result of copying, the blocks B, A, and C are arranged in the SSD, the SSD, and the Online HDD, respectively.

As illustrated in a lower part of FIG. 8, in the degree-of-importance management table 161 of the sub-system, the current physical location 161d for the block A is set to “SSD”, the current physical location 161d for the block B is set to “SSD”, and the current physical location 161d for the block C is set to “Online HDD”. In the different-system physical location 161f, the physical location in a different system (here, the main-system) is set by the degree-of-importance setting part 191 in such a manner that a block of a high degree of importance is copied to a storage device of a high response speed. The different-system physical location 161f for the block A is set to “Online”, the different-system physical location 161f for the block B is set to “SSD”, and the different-system physical location 161f for the block C is set to “NearLine”.

In an upper part of FIG. 9, return copy control of blocks from the storage apparatus 2 of the sub-system to the storage apparatus 1 of the main-system under such conditions is illustrated. In the storage apparatus 2 of the sub-system, the block A is arranged in the Online HDD under the automatic tier control. Furthermore, the block B is arranged in the Online HDD under the automatic tier control. Furthermore, the block C is arranged in the SSD under the automatic tier control.

As illustrated in a lower part of FIG. 9, in the degree-of-importance management table 161 of the sub-system, the current physical location 161d for the block A is set to “Online”, the current physical location 161d for the block B is set to “Online”, and the current physical location 161d for the block C is set to “SSD”.

Then, when the main-system is recovered, the return copy control part 193 copies the blocks to the storage apparatus 1 in descending order of the degree of importance of a volume stored in the degree-of-importance management table 161. In this example, the return copy control part 193 copies a block corresponding to “SYSVOL” of a “high” degree-of-importance, a block corresponding to “DATA” of a “medium” degree-of-importance, and a block corresponding to “TEMP” of a “low” degree of importance in that order.

The return copy control part 193 specifies the different-system physical location 161f stored in the degree-of-importance management table 161 as the arrangement location in the storage apparatus 1. Here, SSD is specified for a block corresponding to “SYSVOL” of a “high” degree-of-importance, Online HDD is specified for a block corresponding to “DATA” of a “medium” degree-of-importance, and Nearline HDD is specified for a block corresponding to “TEMP” of a “low” degree-of-importance.

When the server 3 of the main-system goes down and then is recovered, the return copy control part 193 is capable of causing a block including data of a high degree of importance regarding startup of a server to preferentially return to the storage apparatus 1 of the main-system, as described above. Consequently, the return copy control part 193 is capable of quickly starting the server 3 of the main-system.

Procedure of Degree-of-Importance Setting Process

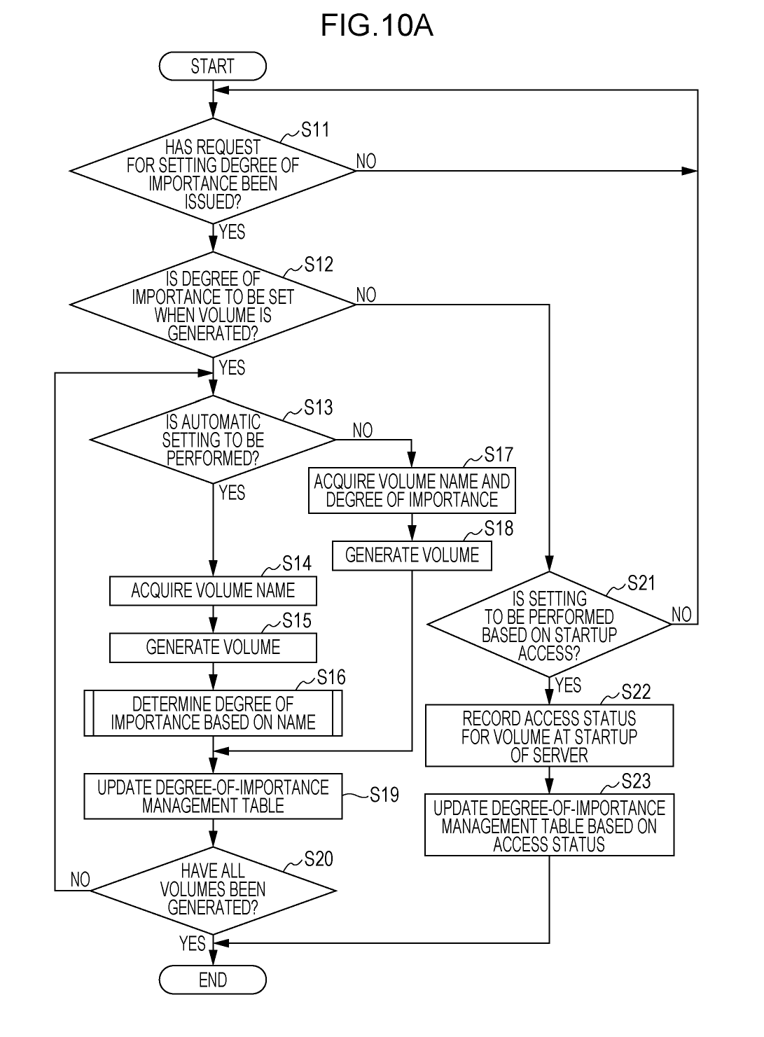

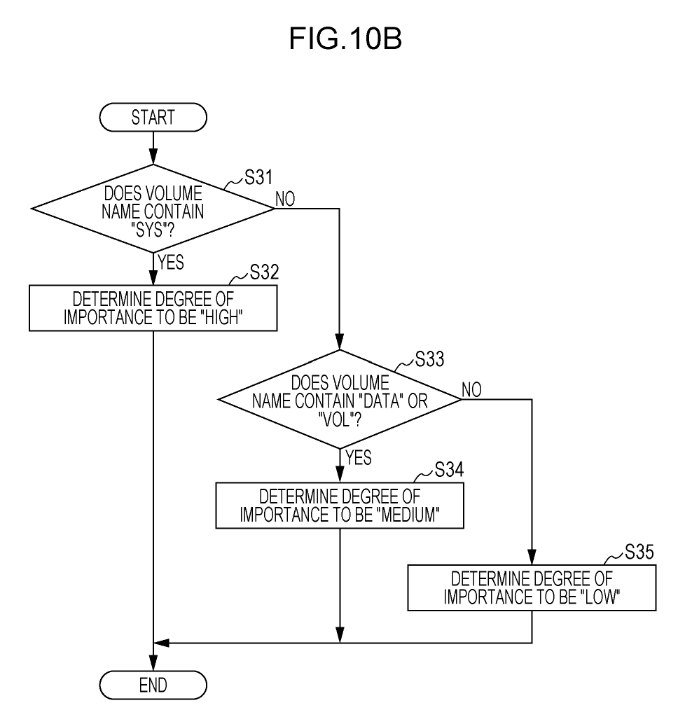

Next, the procedure of a degree-of-importance setting process performed by the storage apparatus 1 of the main-system and the storage apparatus 2 of the sub-system will be explained below with reference to FIGS. 10A and 10B. FIG. 10A is a flowchart of a degree-of-importance setting process according to the first embodiment. FIG. 10B is a flowchart of a process for determining the degree of importance based on a name.

As illustrated in FIG. 10A, the degree-of-importance setting part 191 first determines whether or not a request for setting the degree of importance regarding startup of a server has been issued (step S11). In the case where it is determined that a request for setting the degree of importance has not been issued (NO in step S11), the degree-of-importance setting part 191 repeats the determination processing until a request for setting the degree of importance has been issued.

In contrast, in the case where it is determined that a request for setting the degree of importance has been issued (YES in step S11), the degree-of-importance setting part 191 determines whether or not the degree of importance is to be set at the time when a volume is generated (step S12). For example, the degree-of-importance setting part 191 may determine whether or not the degree of importance is to be set at the time when a volume is generated, by referring to a setting method flag that represents a method for setting the degree of importance and that is set in advance in the RAM 16. Then, in the case where it is determined that the degree of importance is not to be set at the time when a volume is generated (NO in step S12), the degree-of-importance setting part 191 causes the process to proceed to step S21.

In contrast, in the case where it is determined that the degree of importance is to be set at the time when a volume is generated (YES in step S12), the degree-of-importance setting part 191 determines whether or not the degree of importance is to be automatically set (step S13). For example, the degree-of-importance setting part 191 may determine whether or not the degree of importance is to be automatically set, by referring to a setting method flag that represents a method for setting the degree of importance and that is set in advance in the RAM 16.

In the case where it is determined that the degree of importance is to be automatically set (YES in step S13), the degree-of-importance setting part 191 acquires from, for example, the management console 4 the volume name of a volume to be generated (step S14). The degree-of-importance setting part 191 generates a volume having the acquired volume name (step S15). For example, the degree-of-importance setting part 191 generates a volume having the volume name so as to virtually cross over a plurality of storage devices. The plurality of storage devices include storage devices having different response speeds.

Then, the degree-of-importance setting part 191 determines the degree of importance based on the volume name (step S16), and causes the process to proceed to step S19. The process for determining the degree of importance based on a volume name will be explained later with reference to FIG. 10B.

In contrast, in the case where it is determined that the degree of importance is not to be automatically set (NO in step S13), the degree-of-importance setting part 191 acquires, for example, from the management console 4 information of a pair of the volume name and the degree of importance of the volume to be generated (step S17). The degree-of-importance setting part 191 generates the volume having the acquired volume name (step S18), and causes the process to proceed to step S19.

In step S19, the degree-of-importance setting part 191 associates the degree of importance with the volume name, and updates the degree-of-importance management table 161 (step S19). Then, the degree-of-importance setting part 191 determines whether or not all the volumes have been generated (step S20). In the case where it is determined that all the volumes have not been generated (NO in step S20), the degree-of-importance setting part 191 causes the process to return to step S13 to generate the next volume. In contrast, in the case where it is determined that all the volumes have been generated (YES in step S20), the degree-of-importance setting part 191 terminates the process.

In step S21, the degree-of-importance setting part 191 determines whether or not the degree of importance is to be set on the basis of a startup access at the time of startup of the server 3 (step S21). For example, the degree-of-importance setting part 191 may determine whether or not the degree of importance is to be set on the basis of a startup access, by referring to a setting method flag that represents a method for setting the degree-of-importance and that is set in advance in the RAM 16. In the case where it is determined that the degree of importance is not to be set on the basis of a startup access (NO in step S21) the degree-of-importance setting part 191 causes the process to return to step S11.

In contrast, in the case where it is determined that the degree of importance is to be set on the basis of a startup access (YES in step S21), the degree-of-importance setting part 191 records the access status for a volume at the time of startup of the server 3 into the startup access management table 162 (step S22). The access status for a volume includes the access order and the access frequency of the volume. Then, the degree-of-importance setting part 191 determines the degree of importance of the volume on the basis of the recorded access status. Then, the degree-of-importance setting part 191 associates the determined degree of importance with the volume, and updates the degree-of-importance management table 161 (step S23). Then, the degree-of-importance setting part 191 terminates the process.

As illustrated in FIG. 10B, the degree-of-importance setting part 191 determines whether or not the volume name contains “SYS” (step S31). In the case where it is determined that the volume name contains “SYS” (YES in step S31), the degree-of-importance setting part 191 determines that the degree of importance is “high” (step S32).

In contrast, in the case where it is determined that the volume name does not contain “SYS” (NO in step S31), the degree-of-importance setting part 191 determines whether or not the volume name contain “DATA” or “VOL” (step S33). In the case where it is determined that the volume name contains “DATA” or “VOL” (YES in step S33), the degree-of-importance setting part 191 determines that the degree of importance is “medium” (step S34).

In contrast, in the case where it is determined that the volume name does not contain “DATA” or “VOL” (NO in step S33), the degree-of-importance setting part 191 determines that the degree of importance is “low” (step S35). That is, in the case where the volume name contains “TEMP” or “TMP”, the degree-of-importance setting part 191 determines that the degree of importance is “low”.

Procedure of Copy Control Process

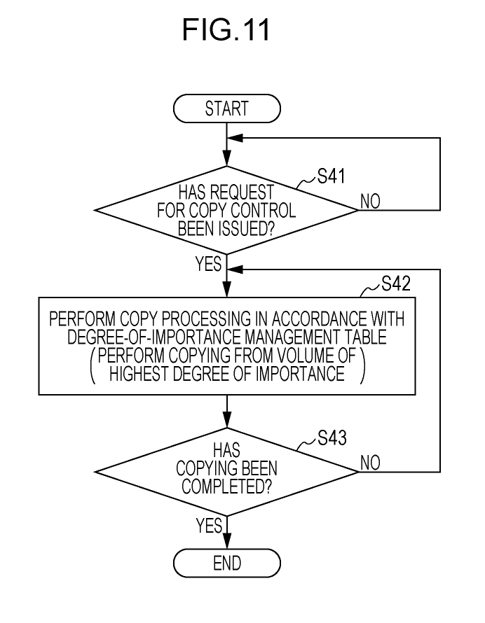

Next, the procedure of a copy control process performed by the storage apparatus 1 of the main-system will be explained below with reference to FIG. 11. FIG. 11 is a flowchart of a copy control process according to the first embodiment. Here, the copy control part 192 performs the copy control process with specific time intervals. Furthermore, in the degree-of-importance management table 161, the correspondence between a volume and the degree of importance is set.

As illustrated in FIG. 11, the copy control part 192 determines whether or not a request for copy control has been issued (step S41). In the case where it is determined that a request for copy control has not been issued (NO in step S41), the copy control part 192 repeats the determination processing until a request for copy control has been issued.

In contrast, in the case where it is determined that a request for copy control has been issued (YES in step S41), the copy control part 192 controls the copy process in such a manner that copying is performed in descending order of the degree of importance of a volume in accordance with the degree-of-importance management table 161 (step S42). For example, the copy control part 192 determines the order of transmission of blocks within volumes, in descending order of the degree of importance of a volume stored in the degree-of-importance management table 161. Then, the copy control part 192 copies the blocks to the storage apparatus 2 of the different system in the determined transmission order. At this time, the copy control part 192 transmits identification information of a block and the different-system physical location, which is the physical location at which the block is to be arranged, as well as the block. The copy control part 192 may acquire the identification information and the different-system physical location of the block from the degree-of-importance management table 161.

Then, the copy control part 192 determines whether or not copying has been completed (step S43). In the case where it is determined that copying has not been completed (NO in step S43), the copy control part 192 causes the process to return to proceed to step S42 to perform copying of a block that has not been copied. In contrast, in the case where it is determined that copying has been completed (YES in step S43), the copy control part 192 terminates the process.

Procedure of Return Copy Control Process

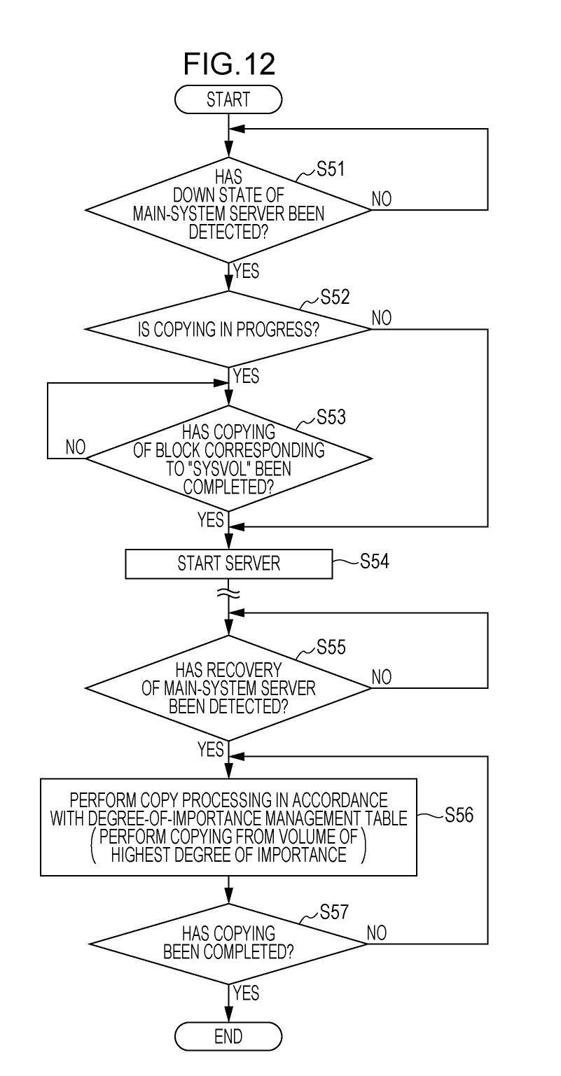

Next, the procedure of a return copy control process performed by the storage apparatus 2 of the sub-system will be explained below with reference to FIG. 12. FIG. 12 is a flowchart illustrating a return copy control process according to the first embodiment. Here, for a volume having the volume name of “SYSVOL”, the degree of importance regarding startup of a server is set to “high”.

The return copy control part 193 determines whether or not a down state of the server 3 of the main-system has been detected (step S51). In the case where the down state of the server 3 of the main-system has not been detected (NO in step S51), the return copy control part 193 repeats the determination processing until the down state of the server 3 of the main-system has been detected. In contrast, in the case where the down state of the server 3 of the main-system has been detected (YES in step S51), the return copy control part 193 determines whether or not a block is being copied from the storage apparatus 1 of the main-system (step S52).

In the case where it is determined that copying is not being performed (NO in step S52), the return copy control part 193 causes the process to proceed to step S54 to start the server 5. In contrast, in the case where it is determined that copying is being performed (YES in step S52), the return copy control part 193 determines whether or not copying of a block corresponding to “SYSVOL” of a “high” degree of importance has been completed (step S53).

In the case where it is determined that copying of a block corresponding to “SYSVOL” has not been completed (NO in step S53), the return copy control part 193 repeats the determination processing until copying of a block corresponding to “SYSVOL” has been completed. In contrast, in the case where it is determined that copying of a block corresponding to “SYSVOL” has been completed (YES in step S53), the return copy control part 193 causes the process to proceed to step S54 to start the server 5. In step S54, the return copy control part 193 starts the server 5 (step S54).

Then, the return copy control part 193 determines whether or not recovery of the main-system has been detected (step S55). In the case where recovery of the main-system has not been detected (NO in step S55), the return copy control part 193 repeats the determination processing until recovery of the main-system has been detected.

In contrast, in the case where recovery of the main-system has been detected (YES in step S55), the return copy control part 193 controls copy processing in such a manner that copying is performed in descending order of the degree of importance of a volume in accordance with the degree-of-importance management table 161 (step S56). For example, the return copy control part 193 determines the order of transmission of blocks within volumes, in descending order of the degree of importance of a volume stored in the degree-of-importance management table 161. Then, the return copy control part 193 copies the blocks to the storage apparatus 1 of the main-system in the determined transmission order. At this time, the return copy control part 193 transmits identification information of a block and the different-system physical location, which is the physical location at which the block is to be arranged, as well as the block. The return copy control part 193 may acquire the identification information and the different-system physical location of the block from the degree-of-importance management table 161.

Then, the return copy control part 193 determines whether or not copying has been completed (step S57). In the case where it is determined that copying has not been completed (NO in step S57), the return copy control part 193 causes the process to return to step S56 to perform copying of a block that has not been copied. In contrast, in the case where it is determined that copying has been completed (YES in step S57), the return copy control part 193 terminates the process.

In the description provided above, at the time of copying a block to the storage apparatus 2, the copy control part 192 transmits identification information of the block and the different-system physical location, which is the physical location at which the block is to be arranged, as well as the block. However, processing of the copy control part 192 is not limited to this. At the time of copying a block to the storage apparatus 2, the copy control part 192 may transmit the current physical location of the block as well as the above-mentioned information. Accordingly, in the case where a block is returned to the storage apparatus 1 of the main-system, the return copy control part 193 of the storage apparatus 2 is capable of issuing an instruction to return the block to the original location. In such a case, in the storage apparatus 2, the current physical location transmitted together with the block may be set in the corresponding different-system physical location 161f in the degree-of-importance management table 161.

Furthermore, in the description provided above, when the server 3 of the main-system enters a down state or the like, the return copy control part 193 starts the server 5 of the sub-system by using data to be used for startup of a server stored in a storage device of the storage apparatus 2 of the sub-system. However, processing of the return copy control part 193 is not limited to this. The return copy control part 193 may simply start the server 5 of the sub-system even in the case where the server 3 of the main-system does not enter the down state or the like. That is, in the case where the server 5 of the sub-system is to be started for some reason, the return copy control part 193 may start the server 5 of the sub-system by using data to be used for startup of a server stored in a storage device of the storage apparatus 2 of the sub-system. Also in such a case, copying of data important for startup of the server 5 is preferentially performed. Thus, the return copy control part 193 is capable of quickly starting the server 5.

Effects of First Embodiment

According to the first embodiment, the storage apparatus 1 changes the arrangement of a block between a plurality of storage devices having different response speeds, in accordance with the access frequency. At the time of copying blocks to the storage apparatus 2 of the different system, the storage apparatus 1 copies the blocks in order from a block including data important for startup of the server 5, from storage devices in which the blocks are currently arranged. With this configuration, the storage apparatus 1 is capable of preferentially performing copying of data important for startup of the server 5. Therefore, the storage apparatus 1 is capable of quickly starting the server 5 of the different system. That is, since copying is preferentially performed from data important for startup of the server 5 of the different system, instead of in units of storage devices, the server 5 of the different system may be quickly started.

Furthermore, according to the first embodiment, the storage apparatus 1 stores, for each volume that is arranged so as to cross over a plurality of storage devices, the degree of importance regarding startup of a server in the degree-of-importance management table 161. Then, the storage apparatus 1 copies blocks in descending order of the degree of importance stored in the degree-of-importance management table 161. With this configuration, by copying blocks in descending order of the degree of importance regarding startup of a server, the storage apparatus 1 is capable of quickly starting the server 5 of the different system. That is, even if a block having the highest degree of importance regarding startup of a server is arranged in a storage device of a low response speed, the storage apparatus 1 is capable of copying the block quickly, regardless of the storage device in which the block is arranged. Consequently, since a block including data important for startup may be acquired quickly, the storage apparatus 1 is capable of quickly starting the server 5 of the different system.

Furthermore, according to the first embodiment, the storage apparatus 1 copies a block including data important for startup of the server 5 to a storage device of the highest response speed. With this configuration, since the block including the data important for startup of the server 5 is arranged in the storage device of the highest response speed, the storage apparatus 1 is capable of starting the server 5 of the different system more quickly.

Furthermore, according to the first embodiment, at the time of generating a volume so as to cross over a plurality of storage devices, the storage apparatus 1 sets the degree of importance based on the name of the volume in the degree-of-importance management table 161. With this configuration, the arrangement of a block is changed within a volume having the same name arranged so as to cross over a plurality of storage devices. Therefore, the storage apparatus 1 is capable of determining the order of transmission of blocks corresponding to volumes in accordance with the degrees of importance of the volumes, regardless of the storage device to which the arrangement of a block is changed.

Furthermore, according to the first embodiment, at the time of generating a volume so as to cross over a plurality of storage devices, the storage apparatus 1 sets the degree of importance corresponding to the volume, on the basis of information of a pair of the name and the degree of importance of the volume. With this configuration, since the arrangement of a block is changed within a volume having the same name arranged so as to cross over a plurality of storage devices, the storage apparatus 1 is capable of determining the order of transmission of blocks corresponding to volumes in accordance with the degrees of importance of the volumes, regardless of the storage device to which the arrangement of a block is changed.

Furthermore, according to the first embodiment, at the time of starting the server 3 of the own system, the storage apparatus 1 sets the degree of importance corresponding to a volume generated so as to cross over a plurality of storage devices, on the basis of the access order and the access frequency of the volume. With this configuration, since the arrangement of a block is changed within a volume having the same name arranged so as to cross over a plurality of storage devices, the storage apparatus 1 is capable of determining the order of transmission of blocks corresponding to volumes in accordance with the degrees of importance of the volumes, regardless of the storage device to which the arrangement of a block is changed.

### Second Embodiment

In the first embodiment, the case has been explained in which at the time of copying blocks to the storage apparatus 2 of the different system, the storage apparatus 1 performs control such that copying of the blocks is performed in descending order of the degree of importance of a volume stored in the degree-of-importance management table 161. However, processing of the storage apparatus 1 is not limited to this. When a writing instruction is issued for a block to be copied during blocks are being copied, copy control may be performed using a queue.

In a second embodiment, the case will be explained below in which when a writing instruction is issued for a block to be copied during data is being copied, a storage apparatus 1A performs copy control using a queue.

Configuration of Storage System

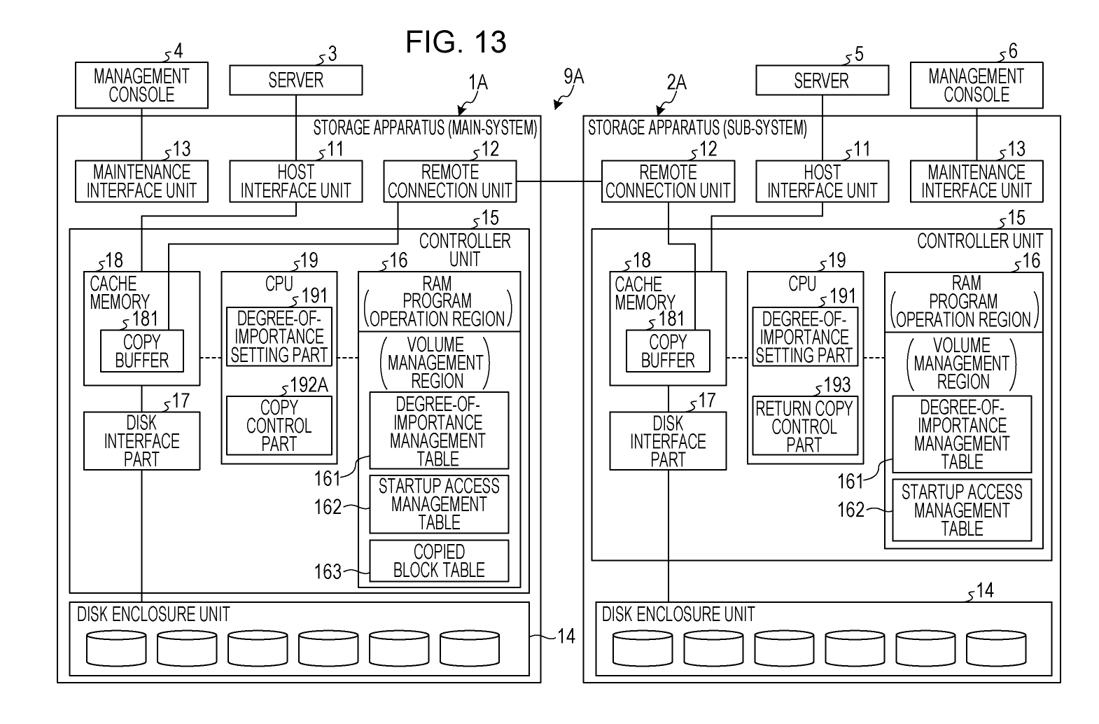

FIG. 13 is a diagram illustrating the hardware configuration of a storage system according to the second embodiment. The same components as those in the storage system 9 illustrated in FIG. 1 will be referred to with the same reference signs, and explanations for the same configuration and operation as the storage system 9 will be omitted. The second embodiment is different from the first embodiment in that a copy control part 192A is provided instead of the copy control part 192 and that a copied block table 163 is additionally provided.

The copy control part 192A copies blocks that have not been copied to a storage apparatus 2A of a different system in descending order of priority with specific time intervals. A specific time interval may be, for example, daily, weekly, or monthly. It is assumed that when the copy control part 192A is performing copying of blocks, a writing instruction is issued for block identification information for which copying is to be performed. If a block corresponding to the block identification information for which the writing instruction is issued has not been copied, the copy control part 192A adds the block for which the writing instruction is issued to a queue. The queue mentioned here represents a “copy queue”. The determination as to whether or not a block corresponding to block identification information has been copied is performed by referring to the copied block table 163, which will be described alter. Upon generation of a writing instruction, the copy control part 192A repeats an operation for adding a block for which a writing instruction is issued to a copy queue until a specific copy processing interval time has been exceeded. The “copy processing interval time” mentioned here represents, for example, a unit in which copy processing regarding a writing instruction is performed. When the specific copy processing interval time has been exceeded, the copy control part 192A sorts blocks within the copy queue in descending order of priority and copies the blocks in the sorted order. Then, the copy control part 192A sets the copied blocks as blocks that have been copied, and updates the copied block table 163. The copy queue corresponds to, for example, the copy buffer 181.

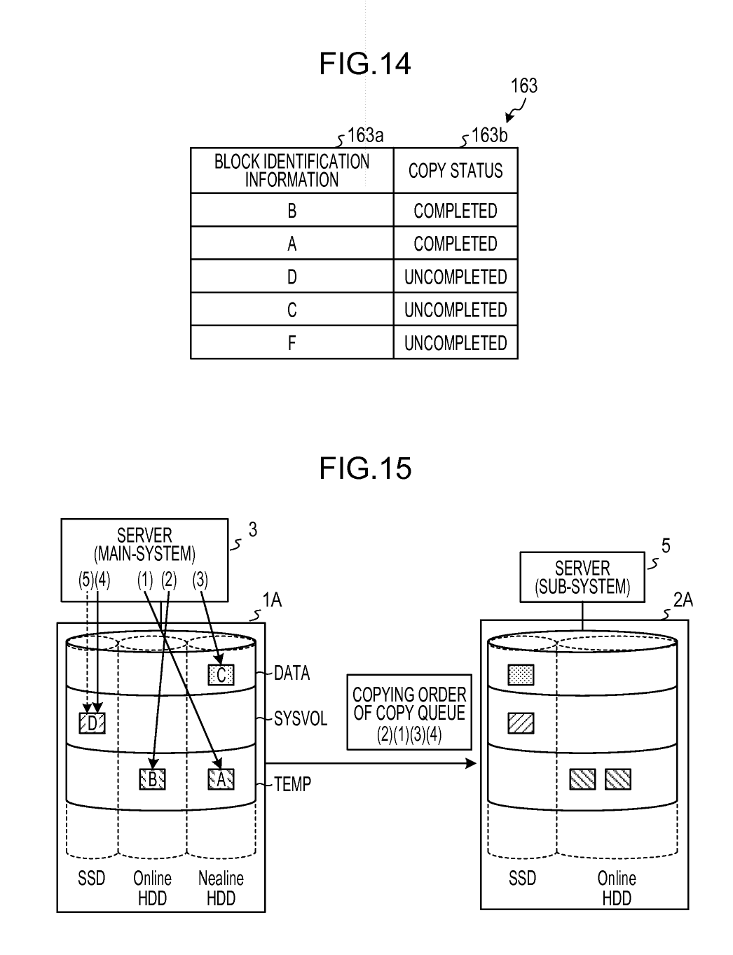

The data structure of the copied block table 163 will now be explained with reference to FIG. 14. FIG. 14 is a diagram illustrating an example of the data structure of a copied block table. As illustrated in FIG. 14, block identification information 163a and a copy status 163b are stored in association with each other in the copied block table 163. The block identification information 163a represents, for example, the physical location at which a block is arranged. For example, at the time of initialization of the copied block table 163, identification information of a block stored in the block information 161b of the degree-of-importance management table 161 is set as the block identification information 163a. As the copy status 163b, a copy status corresponding to identification information of a block is stored. As an example, “completed” representing that copying is completed and “uncompleted” representing that copying is not completed are set as the copy status 163b. As an example, for a block whose identification information 163a is “B”, “completed” is stored as the copy status 163b.

Specific Example of Copy Control

Next, a specific example of copy control will be explained below with reference to FIG. 15. FIG. 15 is a diagram for explaining a specific example of copy control. The degree of importance regarding startup of a server and the current physical location of each volume are stored in the degree of importance 161c and the current physical location 161d of the degree-of-importance management table 161. The degree of importance 161c and the current physical location 161d of a volume having the volume name “SYSVOL” are “high” and “SSD”, respectively. The degree of importance 161c and the current physical location 161d of a volume having the volume name “DATA” are “medium” and “Online”, respectively. The degree of importance 161c and the current physical location 161d of a volume having the volume name “TEMP” are “low” and “NearLine”, respectively. In FIG. 15, since blocks A and B exist in a volume having the volume name “TEMP”, the degree of importance of each of the blocks A and B is “low”. Since a block C exists in a volume having the volume name “DATA”, the degree of importance of the block C is “medium”. Since a block D exists in a volume having the volume name “SYSVOL”, the degree of importance of the block D is “high”.

It is assumed that under such circumstances, as illustrated in FIG. 15, writing instructions are issued for block identification information A, B, C, and D in that order during blocks are being copied. If copying of a block corresponding to block identification information for which a writing instruction is issued has not been completed, the copy control part 192A adds the block to be written to a queue. In this example, it is assumed that copying of blocks corresponding to the block identification information A, B, C, and D has not been completed. The copy control part 192A adds to a copy queue a block (1) to be written to the block identification information A and a block (2) to be written to the block identification information B. Furthermore, the copy control part 192A adds to the copy queue a block (3) to be written to the block identification information C and a block (4) to be written to the block identification information D.

Then, when a specific copy processing interval time has been exceeded since issuance of the first writing instruction for the block identification information A, the copy control part 192A sorts blocks within the copy queue in descending order of priority, and copies the blocks in the sorted order. In this example, the copy control part 192A sorts the blocks in descending order of priority, that is, in the order of the block (4) for the block identification information D, the block (3) for the block identification information C, the block (1) for the block identification information A, and the block (2) for the block identification information B. Then, the copy control part 192A copies the blocks in the sorted order.

It is assumed that after copying of the blocks has been completed, a new writing instruction is issued for block identification information for which copying has been performed. In this case, since the block corresponding to the block identification information for which the writing instruction is issued has already been copied, the copy control part 192A does not set the block as a copy target. That is, even if a new writing instruction is issued for the block identification information D, a block (5) to be written to the block identification information D for which the writing instruction has been issued is not set as a copy target. When the next copy control is requested, the copy control part 192A performs copy control for the block (5) as a copy target.

Detailed Specific Example of Copy Control Process

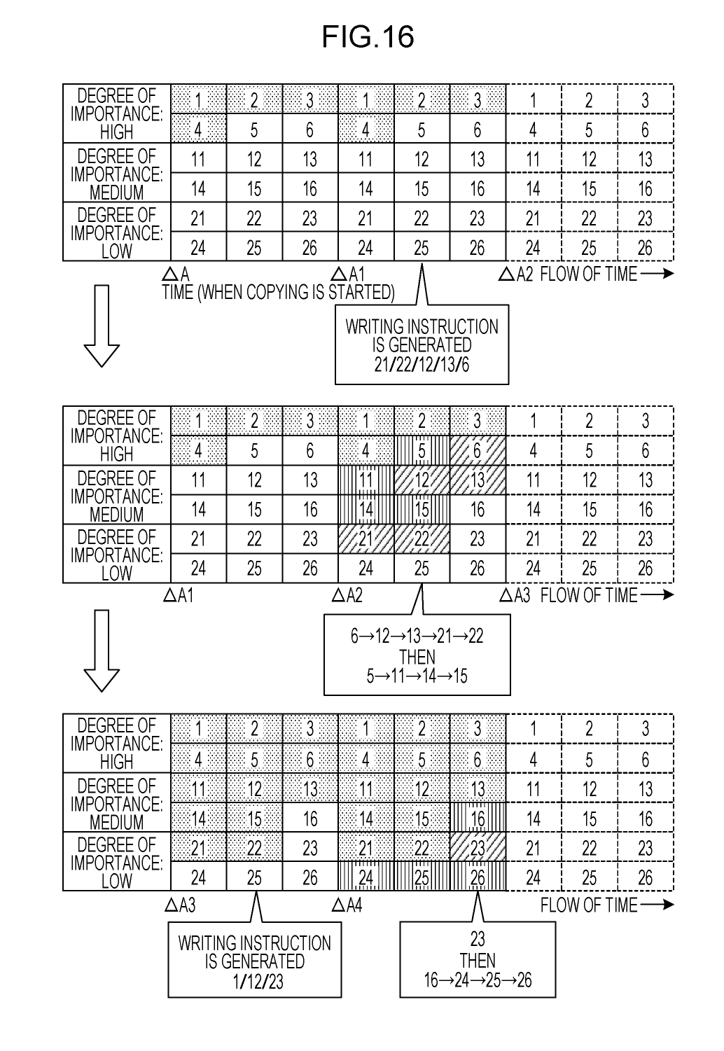

Next, a detailed specific example of copy control will be explained with reference to FIG. 16. FIG. 16 is a diagram for explaining a detailed specific example of copy control. For convenience of explanation, “1” to “6” represent block identification information (block numbers) of volumes of a “high” degree of importance, “11” to “16” represent block identification information of volumes of a “medium” degree of importance, and “21” to “26” represent block identification information of volumes of a “low” degree of importance.

As illustrated in an upper part of FIG. 16, at a point in time A when copying is started, the copy control part 192A copies blocks corresponding to block identification information for which copying has not been performed in descending order of priority. In this example, the copy control part 192A copies blocks corresponding to the block identification information 1, 2, 3, and 4 in descending order of priority. Then, at a point in time A1, a writing instruction is generated for the block identification information 21. Furthermore, during a copy processing interval time between A1 and A2, writing instructions for the block identification information 21, 22, 12, 13, and 6 are generated. Then, if blocks corresponding to block identification information have not been copied, the copy control part 192A adds to a copy queue the blocks to be written in the order in which the writing instructions were generated. Blocks to be written to the block identification information 21, 22, 12, 13, and 6 are added to the copy queue in accordance with the writing instructions.

As illustrated in a medium part of FIG. 16, since the copy processing interval time has been exceeded, the copy control part 192A sorts the blocks within the copy queue in descending order of priority, and copies the blocks in the sorted order. In this example, the blocks are copied in the order of the block identification information 6, 12, 13, 21, and 22. Then, the copy control part 192A copies blocks corresponding to block identification information for which copying has not been performed, in descending order of priority. In this example, the blocks are copied in the order of the block identification information 5, 11, 14, and 15.

As illustrated in a lower part of FIG. 16, at a point in time A3, a writing instruction is generated for the block identification information 1. Furthermore, during a copy processing interval time between A3 and A4, writing instructions are generated for the block identification information 12 and 23. Then, if blocks corresponding to block identification information have not been copied, the copy control part 192A adds to a copy queue the blocks to be written, in the order in which the writing instructions were generated. In this example, a block corresponding to the block identification information 23 is added to the copy queue. Since blocks corresponding to the block identification information 1 and 12 have already been copied, the blocks are not set as copy targets and thus are not added to the copy queue.

Then, at a point in time A4, since the copy processing interval time has been exceeded, the copy control part 192A sorts the blocks within the copy queue in descending order of priority, and copies the blocks in the sorted order. In this example, the block corresponding to the block identification information 23 is copied. Then, the copy control part 192A copies blocks corresponding to block identification information for which copying has not been performed, in descending order of priority. In this example, the blocks are copied in the order of the block identification information 16, 24, 25, and 26.

Procedure of Copy Control Process

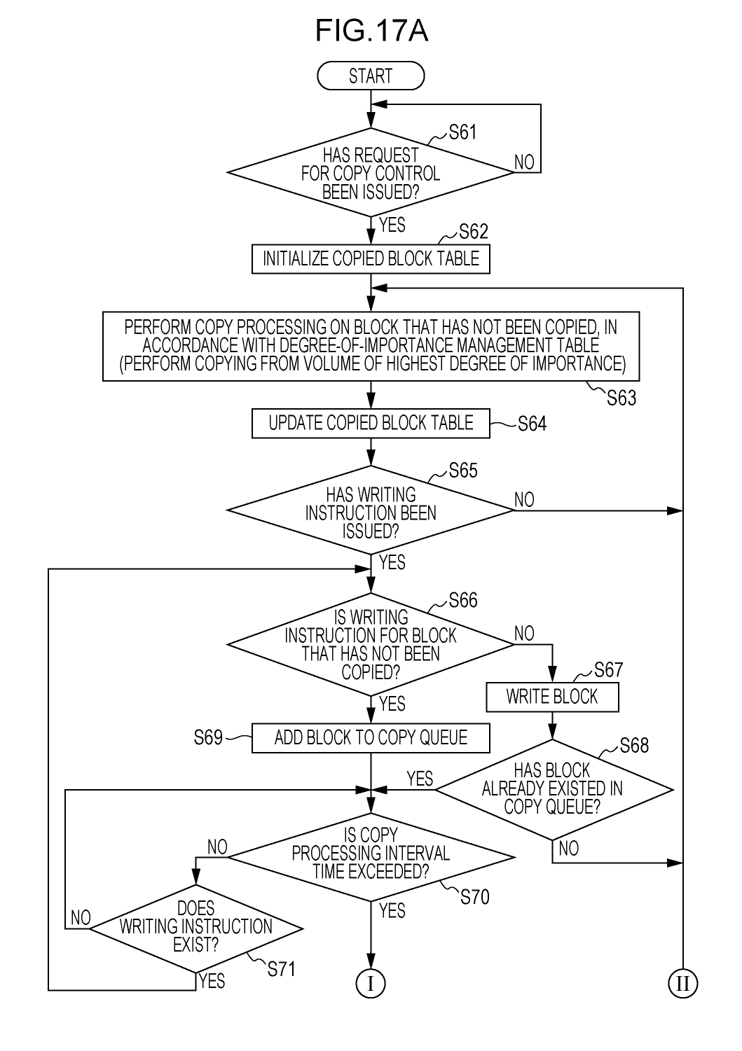

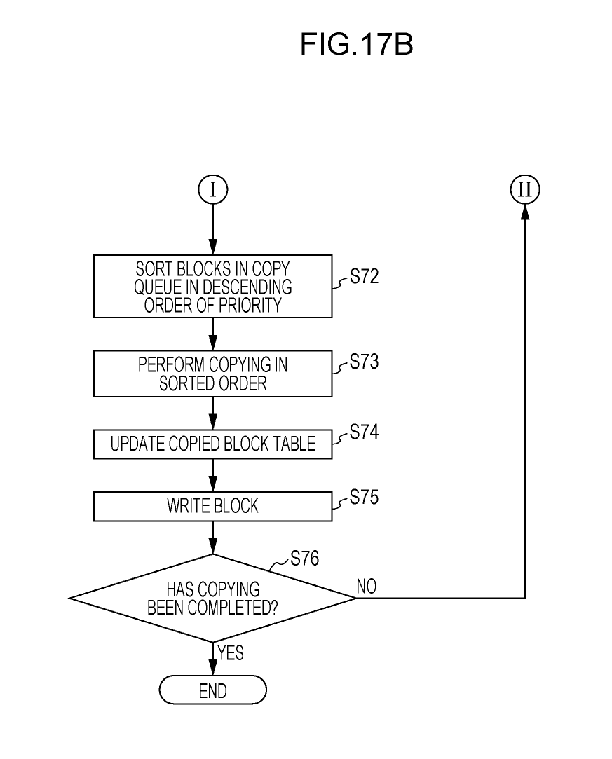

Next, the procedure of a copy control process performed by the storage apparatus 1A of the main-system will be explained below with reference to FIGS. 17A and 17B. FIGS. 17A and 17B are flowcharts of a copy control process according to the second embodiment. The copy control part 192A is configured to perform the copy control process with specific time intervals. Furthermore, the correspondence between a volume and the degree of importance is set in the degree-of-importance management table 161.

As illustrated in FIGS. 17A and 17B, the copy control part 192A determines whether or not a request for copy control has been issued (step S61). In the case where it is determined that a request for copy control has not been issued (NO in step S61), the copy control part 192A repeats the determination processing until a request for copy control has been issued.

In contrast, in the case where it is determined that a request for copy control has been issued (YES in step S61), the copy control part 192A initializes the copied block table 163 (step S62). For example, the copy control part 192A sets, as the block identification information 163a of the copied block table 163, identification information of blocks stored in the block information 161b of the degree-of-importance management table 161. Then, the copy control part 192A sets, as the copy status 163b of the copied block table 163, “uncompleted”, which represents that copying has not been completed.

Then, the copy control part 192A controls copy processing in such a manner that blocks that have not been copied are copied in descending order of the degree of importance of a volume, in accordance with the degree-of-importance management table 161 (step S63). For example, the copy control part 192A copies to the storage apparatus 2A of the different system blocks that have not been copied within volumes, in descending order of the degree of importance of a volume stored in the degree-of-importance management table 161.

Then, the copy control part 192A sets block identification information of the copied blocks as blocks that have been copied, and updates the copied block table 163 (step S64).

Then, the copy control part 192A determines whether or not a writing instruction has been issued (step S65). In the case where it is determined that a writing instruction has not been issued (NO in step S65), the copy control part 192A causes the process to return to step S63 to copy blocks that have not been copied. In contrast, in the case where it is determined that a writing instruction has been issued (YES in step S65), the copy control part 192A determines whether or not a block corresponding to block identification information for which the writing instruction has been issued is a block that has not been copied (step S66).

In the case where it is determined that a block corresponding to block identification information for which the writing instruction has been issued is not a block that has not been copied (NO in step S66), the copy control part 192A does not set the block to be written as a copy target since the block corresponding to the block identification information has already been copied. The copy control part 192A writes the block for which the writing instruction has been issued to block identification information in a storage device represented by the current physical location (step S67). Accordingly, since the copy control part 192A writes the block that is to be written and that is not set as a copy target into the storage device, the integrity of data included in the block may be ensured. Then, the copy control part 192A determines whether or not a block has already existed in a copy queue (step S68).

In the case where it is determined that a block has already existed in the copy queue (YES in step S68), the copy control part 192A causes the process to proceed to step S70 to perform a determination regarding a copy processing interval time. In contrast, in the case where it is determined that a block has not existed in the copy queue (NO in step S68), the copy control part 192A causes the process to return to step S63 to copy a block that has not been copied.

In contrast, in the case where it is determined that a block corresponding to the block identification information for which the writing instruction has been issued is a block that has not been copied (YES in step S66), the copy control part 192A adds the block to be written to a copy queue (step S69). Then, the copy control part 192A determines whether or not the copy processing interval time has been exceeded (step S70).

In the case where it is determined that the copy processing interval times has not been exceeded (NO in step S70), the copy control part 192A determines whether or not another writing instruction has been issued (step S71). In the case where it is determined that another writing instruction has been issued (YES in step S71), the copy control part 192A causes the process to return to step S66 to perform processing for the writing instruction. In contrast, in the case where it is determined that another writing instruction has not been issued (NO in step S71), the copy control part 192A causes the process to return to step S70 to perform a determination regarding the copy processing interval time.

In contrast, in the case where it is determined that the copy processing interval time has been exceeded (YES in step S70), the copy control part 192A sorts the blocks in the copy queue in descending order of priority (step S72). For example, the copy control part 192A sorts the blocks within the copy queue in descending order of the degree of importance of a block in a volume stored in the degree-of-importance management table 161.

Then, the copy control part 192A copies to the storage apparatus 2A of the different system the blocks within the copy queue in the sorted order (step S73). Then, the copy control part 192A sets the block identification information of the copied blocks as “completed”, and updates the copied block table 163 (step S74). Furthermore, the copy control part 192A writes the copied blocks to the block identification information in the storage devices represented by the current physical locations (step S75). Accordingly, since the blocks added to the copy queue may be written to the storage devices in units of copy processing interval times, the copy control part 192A is capable of ensuring the integrity of data included in the blocks.

Then, the copy control part 192A determines whether or not copying has been completed (step S76). In the case where it is determined that copying has not been completed (NO in step S76), the copy control part 192A causes the process to return to step S63 to copy a block that has not been copied. In contrast, in the case where it is determined that copying has been completed (YES in step S76), the copy control part 192A terminates the process.

Effects of Second Embodiment

According to the second embodiment, when a writing instruction is generated during blocks are being copied, the copy control part 192A performs processing for writing instructions for a copy processing interval time from the point in time when the writing instruction was generated. That is, if copying of a block corresponding to a writing instruction has not been performed, the copy control part 192A adds a block to be written to a queue. Then, after the copy processing interval time has passed, the copy control part 192A sorts the blocks included in the queue in descending order of the degree of importance, and copies the blocks in the sorted order. With this configuration, even if a writing instruction is issued during blocks are being copied, the copy control part 192A sorts blocks within the queue in accordance with the degrees of importance corresponding to the writing destinations for which the writing instructions were issued. Therefore, the server 5 of the different system may be quickly started.

Others

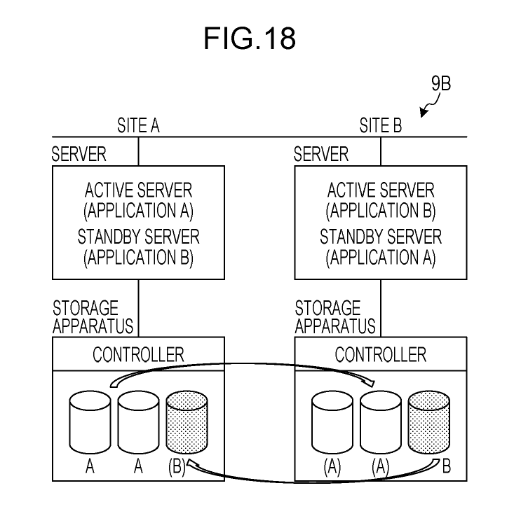

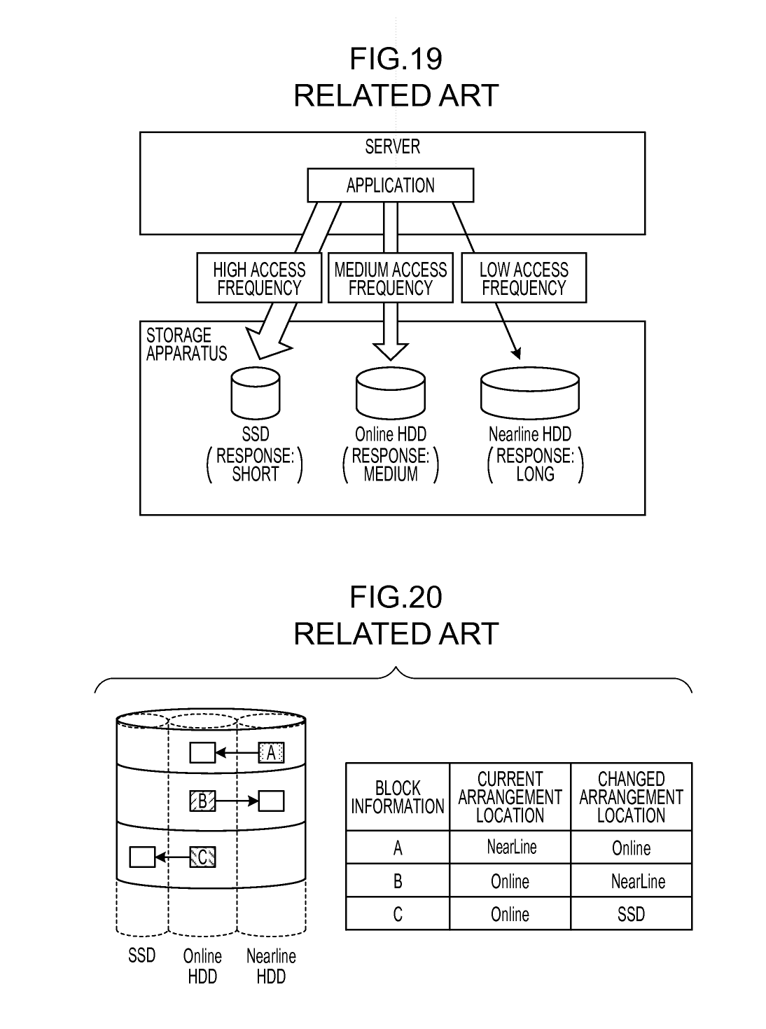

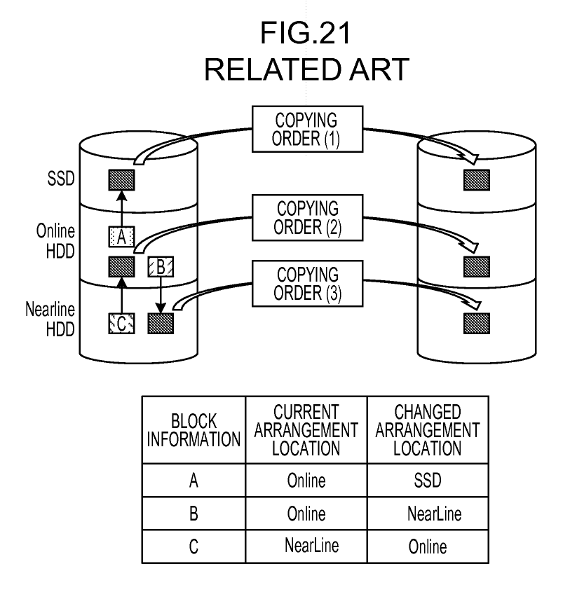

As stated above, in the illustrated storage systems 9 and 9A, the storage apparatuses 1 and 1A are defined as main-systems, and the storage apparatuses 2 and 2A are defined as sub-systems (standby systems). However, the configuration of the storage systems 9 and 9A is not limited to this. Another example of the configuration of a storage system will be described below with reference to FIG. 18.

FIG. 18 is a diagram illustrating another example of the configuration of a storage system. As illustrated in FIG. 18, a storage system 9B has a configuration in which both a storage apparatus on a site A and a storage apparatus on a site B are operating (active). That is, for an application A, the site A operates as a primary site (main-system), and the site B is in a standby state as a secondary site (sub-system). In contrast, for an application B, the site B operates as a primary site (main-system), and the site A is in a standby state as a secondary site (sub-system). Data on the application A is copied from the site A to the site B, and enters a standby state on the site B. In contrast, data on the application B is copied from the site B to the site A, and enters a standby state on the site A. Here, for example, if a server on the site A goes down, data on the application A being operated on the site A comes to be operated on the site B. Then, when the server on the site A is recovered, the data is copied from the site B to the site A.

Furthermore, the CPU 19 of the illustrated storage apparatus 1 may further include the return copy control part 193, and the CPU 19 of the illustrated storage apparatus 2 may further include the copy control part 192. Furthermore, the CPU 19 of the illustrated storage apparatus 1A may further include the return copy control part 193, and the CPU 19 of the illustrated storage apparatus 2A may further include the copy control part 192A. That is, any storage apparatus is capable of performing a copy control process and a return copy control process.

Furthermore, the components of the illustrated storage apparatuses 1 and 1A do not necessarily physically have the illustrated configurations. That is, specific forms of distribution and integration of the storage apparatuses 1 and 1A are not limited to the illustrated forms. All or part of the storage apparatuses 1 and 1A may be configured in a functionally or physically distributed or integrated manner in desired units, in accordance with various loads, use conditions, and the like. For example, the degree-of-importance setting part 191 and the copy control part 192 may be integrated into one part. The degree-of-importance setting part 191 may be divided into a first setting part that sets the degree of importance in accordance with the name of a volume, a second setting part that sets the degree of importance in accordance with information of a pair of the name and the degree of importance of a volume, and a third setting part that sets the degree of importance at the time of access startup.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A storage apparatus comprising:
a plurality of drives having different response speeds;
a memory that stores location information of data stored in the plurality of drives; and
a processor operable to execute:
performing rearrangement of the data among the plurality of drives in accordance with a specific condition;
updating the location information of the data whose rearrangement has been performed; and
starting copying from data that is used for startup of a host connected to another storage apparatus among a plurality of pieces of data to be copied to the other storage apparatus in accordance with the location information stored in the memory, the other storage device being redundantly configured with the storage apparatus.

2. The storage apparatus according to claim 1,
wherein the memory stores degree-of-importance information representing degree of importance for each pieces of data, and
wherein at a time of copying the data to the other storage apparatus, the processor copies the data based on the degree-of-importance information.

3. The storage apparatus according to claim 1,
wherein the processor copies the data to be used for startup of the host so as to be arranged in one of the drives having the highest response speed.

4. The storage apparatus according to claim 2,
wherein the processor sets, for each volume generated so as to cross over the plurality of drives, degree of importance of data stored in the volume, and stores degree-of-importance information representing the degree of importance into the memory.

5. The storage apparatus according to claim 2,
wherein the processor sets, at a time of generating a volume so as to cross over the plurality of drives, degree-of-importance information representing degree of importance of data stored in the volume into the memory based on information of a pair of a volume name and the degree of importance of the volume.

6. The storage apparatus according to claim 2,
wherein the processor sets degree of importance of data stored in a volume generated so as to cross over the plurality of drives based on an access order of the volume and an access frequency of the volume, and stores degree-of-importance information representing the degree of importance into the memory.

7. The storage apparatus according to claim 2,
wherein when data in a write instruction received from a host connected to the storage apparatus has not been copied during data is being copied to the other storage apparatus, the processor adds the data in the write instruction to a queue, and copies the data added to the queue based on the degree-of-importance information representing the degree of importance of the data added to the queue.

8. A copy control method for a storage apparatus with a plurality of drives having different response speeds, the method comprising:
storing location information of data stored in the plurality of drives;
performing rearrangement of the data among the plurality of drives in accordance with a specific condition;
updating the location information of the data whose rearrangement has been performed; and
starting copying, in accordance with the location information stored in the memory, from data to be used for startup of a host connected to another storage apparatus among a plurality of pieces of data to be copied to the other storage apparatus, which is redundant with respect to the storage apparatus.
